(19) United States
(12) Patent Application Publication
(10) Pub. No.: US 2003/0031464 A1
(43) Pub. Date: Feb. 13, 2003

(54) Method for reproducing multiple audio/video files from an optical information recording medium according to various schedules

(75) Inventors: Ming-Teh Ho, Chung-Ho City (TW); Hong-Ming Lin, Chung-Ho City (TW)

Correspondence Address: TROXELL LAW OFFICE PLLC, SUITE 1404, 5205 LEESBURG PIKE, FALLS CHURCH, VA, 22041, US

(73) Assignee: DATAVIDEO TECHNOLOGIES CO., LTD.

(21) Appl. No.: 10/067,940

(22) Filed: Feb. 8, 2002

(30) Foreign Application Priority Data
Aug. 10, 2001 (TW) 90124811

(51) Int. Cl. H04N 5/92; H04N 5/781

(52) U.S. Cl. 386/83; 386/126

(57) ABSTRACT

The invention is to provide a method for reproducing a plurality of audio/video files from an optical information recording medium in accordance with at least one schedule file. In a preferred embodiment of the invention, seven schedule files, which each corresponds to one of seven days of a week, are created. The seven schedule files and the audio/video files are recorded onto the optical information recording medium. When a user want to reproduce the audio/video files from the optical information recording medium, according to a current day of the week, the schedule file corresponding to the current day is retrieved from the optical information recoding medium. Then, the audio/video files are reproduced from the optical information recording medium according to the retrieved schedule file.

### FIELD OF THE INVENTION

The present invention relates to a method for recording and reproducing a large quantity of optical information, and particularly, to a method for reproducing a large quantity of optical information according to at least one playback schedule.

### BACKGROUND OF THE INVENTION

As audio/video (A/V) multimedia has become popular, the optical information recording media with large storage capacity are usually used to store the A/V multimedia files. Based on the quantity of A/V multimedia files, A/V multimedia information can be divided into two categories: small quantity of A/V information and large quantity of A/V information. The small quantity of A/V information is mostly used at home or for personal use. The large quantity of A/V information is mostly used for commercial purposes, such as advertisements or programs broadcasted on large outdoor electronic displays or TV walls.

Since the large quantity of A/V information is applied in commercial field, the broadcast effect of the A/V information on viewers must be carefully evaluated. Hereinafter, the broadcast effect of the effect on viewers is referred as “viewer impact”. The so-called “viewer impact” usually depends on playback schedule, e.g., the playback sequence and playback times of the A/V files. That is, it is best to “viewer impact” that proper programs or advertisements can be played back at specific and on specific location.

As well known in prior arts, an optical information recording medium in Universal Disk format (UDF) or ISO 9660 format has a management information area for storing address information regarding files or programs, information defining reproducing (playback) conditions and other information. Such optical information recording medium also has a data area for storing files or programs. The related prior arts involving the information arrangement in the management information area of the optical information recording medium refer to U.S. Pat. No. 6,198,877, No. 5,978,336 and No. 5,902,115. However, the prior arts regarding the reproduction of the A/V files from the optical information recording medium always carry out according to the sequence of files listed in the TOC (table of content) or the track numbers. That is the prior arts regarding the reproduction of the AN files can not provide with function of playing back specific A/V files according to a predetermined schedule.

Otherwise, the multimedia advertisements are broadcasted just by the prior arts of the reproduction of the A/V files, the advertisements hardly attract and interest the potential consumers passed by the locations where the advertisements are broadcasted. Since conventional broadcast of the advertisements is always according to the track numbers of the optical information recording medium, it overlooks the population appearing on specific location and at specific time. Anyway, the conventional broadcast of the A/V files or advertisements can not target potential consumers and get better “viewer impact”.

Accordingly, an objective of the invention is to provide a method for storing and reproducing a plurality of A/V files. Moreover, the method of the invention edits at least one reproducing schedule files, and then reproduces the A/V files according to the reproducing schedule file.

### SUMMARY OF THE INVENTION

It is, therefore, the primary objective of the present invention to provide a method for recording and reproducing a plurality of audio/video files, and more in particular, to a method for reproducing the audio/video files according various schedule files. Thereby, the broadcast of the audio/video files can target the potential consumers.

According to a preferred embodiment of the invention, a method is provided for recording seven schedule files and a plurality of audio/video files onto an optical information recording medium, and then for reproducing the audio/video files from the optical information recording medium according to the seven schedule files. The optical information recording medium has a plurality of tracks. At first, the seven schedule files are created, wherein each schedule file corresponds to one of seven days of a week, and is provided with the track numbers and a plurality of starting times, respectively. In each schedule file, each starting time corresponds to one of the track numbers. Afterwards, the seven schedule files are recorded onto the optical information recording medium, and the audio/video files are recorded onto the corresponding tracks of the optical information recording medium. Next, when users want to reproduce the audio/video files from the optical information recording medium, according to a current day of the week, the schedule file corresponding to the current day is retrieved from the optical information recoding medium. Then, according to the retrieved schedule file, the method of the invention monitors whether one of the starting times comes, and if yes, the track number corresponding to the starting time coming is taken as a reproducing track number. Finally, the audio/video file recorded on the track, which the reproducing track number indicates, is retrieved, and the retrieved the retrieved audio/video file is reproduced.

These and other objectives of the present invention will no doubt become obvious to those of ordinary skill in the art after reading the following detailed description of the preferred embodiment, which is illustrated in the various FIGS. and drawings.

### BRIEF DESCRIPTION OF THE DRAWINGS

FIG. 1A is a block diagram showing the method for recording/reproducing from an optical information recording system 10 according to the invention.

FIG. 1B is a block diagram showing the method for recording/reproducing from an optical information reproducing system 20 according to the invention.

FIG. 2 is a flowchart showing the first preferred embodiment of the invention.

FIG. 3 is a flowchart showing the third preferred embodiment of the invention.

FIG. 4 is an example of a schedule file corresponding to Saturday in the fourth preferred embodiment of the invention.

### DETAILED DESCRIPTION OF THE INVENTION

The present invention is to provide an optical information recording/reproducing method. The method according to the invention records a schedule file and a plurality of audio/video files onto an optical information recording medium, and then reproduces the plurality of audio/video files from the optical information recording medium in accordance with the schedule file. Hereinafter, embodiments of the present invention will be explained with reference to the attached drawings. Referring to the drawings, preferred embodiments of the present invention will be explained in details.

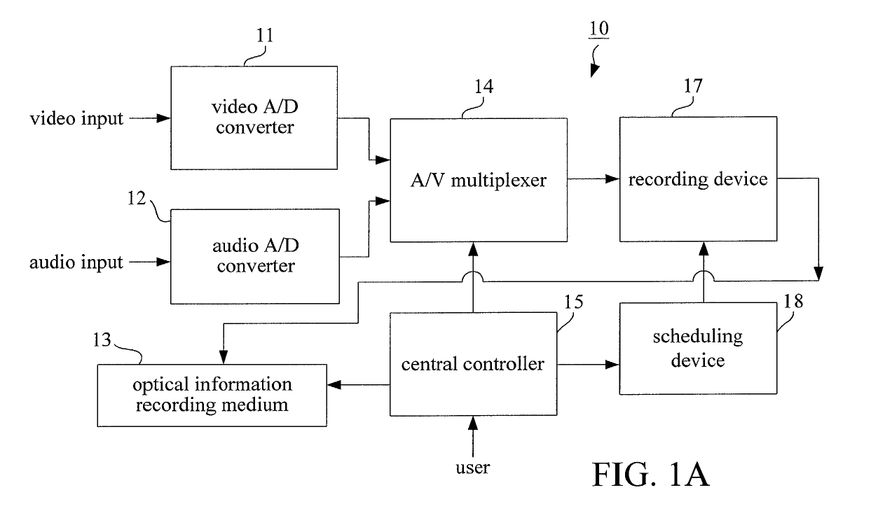

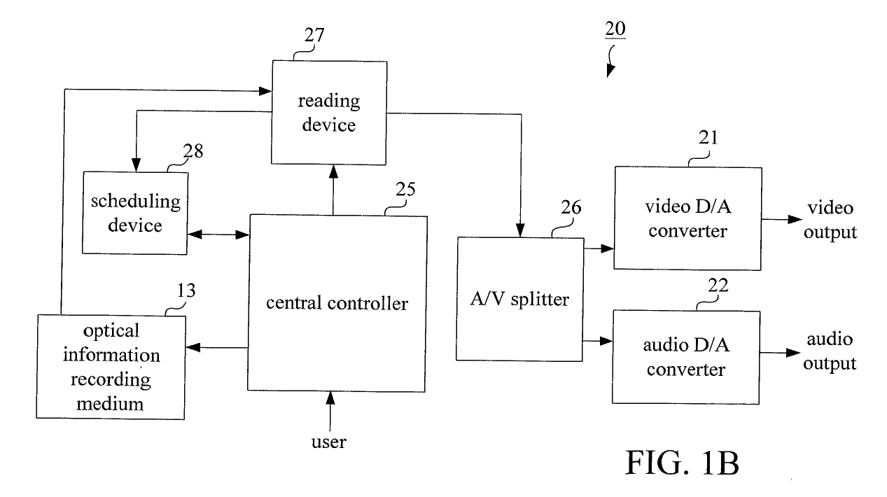

Referring to FIG. 1A, FIG. 1A is a block diagram showing an optical information recording system 10 with which the recoding procedure in the method according the invention can be implemented. The optical information recording system 10 includes a scheduling device 18 for editing one or more schedule files. Referring to FIG. 1B, FIG. 1B is a block diagram showing an optical information reproducing system 20 with which the reproducing procedure in the method according to the invention can be implemented. The optical information reproducing system 20 includes a scheduling device 28 for reproducing the plurality of audio/video files by monitoring the schedule files. Followings will describe the major function blocks and the controlling procedures of the optical information recording system 10 and the optical information reproducing system 20, and operation regarding the scheduling devices 18 and 28 during the recording and reproducing procedures.

With the optical information recording system 10, the method according to the invention enables recording of audio/video files and schedules files onto an optical information recording medium 13 as shown in FIG. 1A. At first, a video input signal is converted and compressed by a video A/D converter 11 into compressed digital video information. At the same time, an audio input signal is converted and compressed by an audio A/D converter 12 into compressed digital audio information.

Then, a user operates a central controller 15 to control an A/V multiplexer 14 to combine the compressed digital video and audio information into an audio/video file to be recorded. The audio/video file is then recorded onto the optical information recording medium 13 with a recording device 17.

With respect to editing and recording of the schedule file, the user controls a scheduling device 18 to edit at least one schedule file by using the central controller 15. The user then can record the schedule file onto the optical information recording medium 13 with the recording device 17.

With the optical information reproducing system 20, the method according to the invention enables reproducing of the audio/video files and schedule files from the optical information recording medium as shown in FIG. 1B. On the optical information recording medium 13, the plurality of audio/video files and at least one schedule file have been recorded. At first, the user controls a reading device 27 to retrieve the least one schedule file by using a central controller 25, and stores the least one schedule file in the scheduling device 28. The scheduling device 28 also has timing function. Thereby, the scheduling device 28 functions monitoring the time recorded in the at least one schedule file to know whether the time comes.

When the scheduling device 28 detects that the time recorded in the schedule file is coming, the central controller 25 retrieves the plurality of audio/video files with the reading device 27 according to the reproducing schedule information of the schedule file. Then, the central controller 25 controls an A/V splitter 26 to divide the retrieved audio/video files into video information and audio information.

Subsequently, a video D/A converter 21 and an audio D/A converter 22 are used to decompress and convert the video information and audio information, respectively, into the video output signal and audio output signal such that the audio/video files are reproduced.

In practical application, the optical information recording system 10 and the optical information reproducing system 20 may be combined as an optical information recording/reproducing system wherein the recording device 17 and the reading device 27 are combined as an apparatus with recording and reading features, and the central controller 15 and the central controller 25 are the same controller. Also, the scheduling device 18 and the scheduling device 28 are the same device which can edit, store and monitor/detect the schedule files.

Hereinafter, several preferred embodiments of the present invention will be explained with reference to the attached drawings.

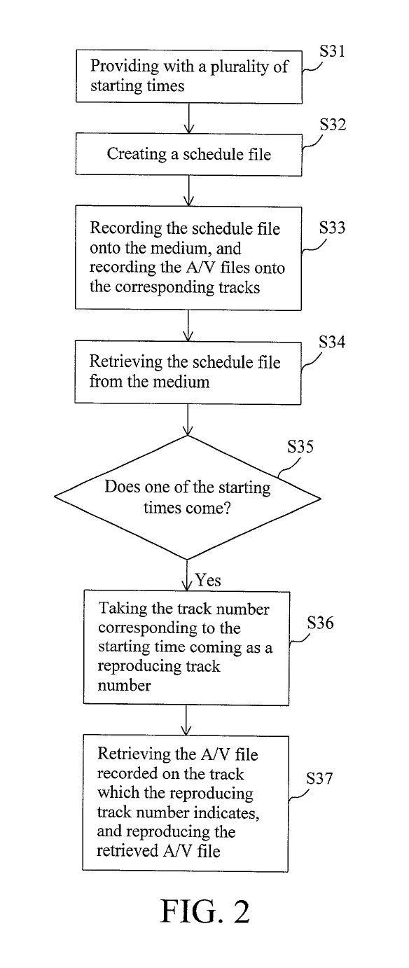

In a first preferred embodiment of the invention, only one schedule file is edited and applied. Referring to FIG. 2, FIG. 2 is a flowchart illustrating the first preferred embodiment of the present invention. The method according the first preferred embodiment of the invention is for recording a plurality of audio/video files and a schedule file onto an optical information recording medium, and then for reproducing the plurality of audio/video files from the optical information recording medium according to the schedule file recorded on the optical information recording medium. The optical information recording medium has a plurality of tracks. Each audio/video file corresponds to one of the tracks. A plurality of track numbers are defined, and each track number indicating one of the tracks.

As shown in FIG. 2, the optical information recording procedure is performed as the following steps: in step S31, providing with a plurality of starting times which each corresponds to one of track numbers; in step S32, creating a schedule file including the track numbers and the corresponding starting times; in step S33, recording the schedule file onto the optical information recording medium, and recording the audio/video files onto the corresponding tracks of the optical information recording medium.

When the user wants to playback the audio/video files from the optical information recording medium, the optical information reproducing procedure is performed as the following steps. In step S34, the method according to the first preferred embodiment retrieves the schedule file from the optical information recording medium. Then step S35 is performed, according to the schedule file, to monitor whether one of the starting times comes. If the answer in step S35 is “Yes”, step S36 is performed to take the track number corresponding to the starting time coming as a reproducing track number, and then step S37 is performed. In step S37, the method according to the first preferred embodiment retrieves the audio/video file recorded on the track which the reproducing track number indicates, and reproduces the retrieved audio/video file.

A second preferred embodiment of the present invention is based on the first preferred embodiment of the present invention with modifications. The optical information recording procedure according to the second preferred embodiment of the present invention is similar to the steps from S31 to S33, shown as FIG. 2. The difference between the two preferred embodiments is that the second preferred embodiment provides with a plurality of ending times which each corresponds to one of the track numbers in step S31, and the schedule file also includes the corresponding ending times in step S32. The optical information reproducing procedure according to the second preferred embodiment carries out the steps from S34 to S37, as shown in FIG. 2. After step S37, the method according to the second preferred embodiment repeatedly reproduces the retrieved audio/video file until the ending time, corresponding to the reproducing track number, comes.

The number of the schedule files in a period may be decided based on the location where the audio/video files are played. In such way, it is possible to playback the proper audio/video file to the potential consumer passing by the location. For example, seven schedule files may be created wherein each schedule file corresponds to one of seven days of a week; or thirty schedule files may be created wherein each schedule file corresponds to one of thirty days of a month.

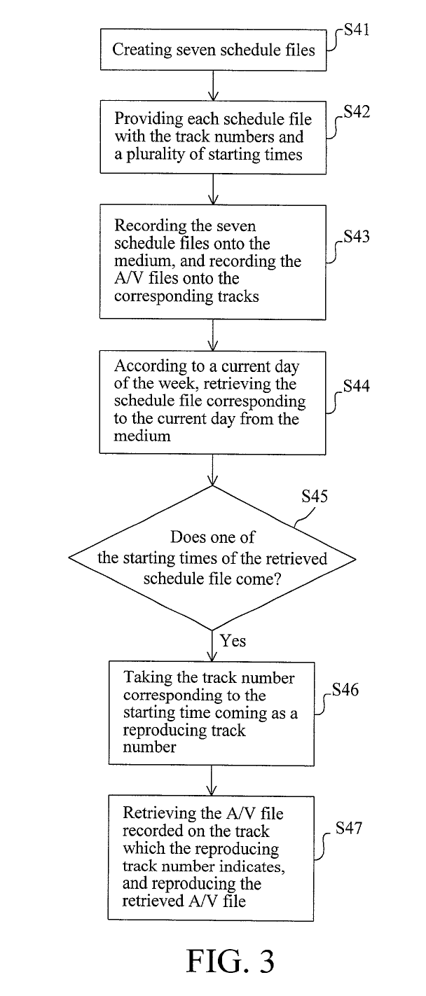

Following takes one week as an example in which seven schedule files are created and then a plurality of audio/video files are played back according to the schedule files. Referring to FIG. 3, FIG. 3 is a flowchart illustrating the third preferred embodiment of the present invention. The method according to the third preferred embodiment of the invention is to record the seven schedule files and the plurality of audio/video files onto an optical information recording medium, and then reproduce the audio/video files from the optical information recording medium according to the seven schedule files. The optical information recording medium has a plurality of tracks wherein each audio/video file corresponds to one of the tracks. A plurality of track numbers are defined, and each track number indicates one of the tracks.

In FIG. 3, at first, the optical information recording procedure is performed as the following steps. In step S42, seven schedule files are created wherein each schedule file corresponds to one of seven days of a week, from Monday to Sunday. In step S42, each schedule file is provided with the track numbers and a plurality of starting times, respectively. An in each schedule file, each starting time corresponds to one of the track numbers. In step S43, the seven schedule files are recorded onto the optical information recording medium, and the audio/video files are recorded onto the corresponding tracks of the optical information recording medium.

When the user wants to playback a plurality of audio/video files from the optical information recording medium, the optical information reproducing procedure is performed as the following steps. In step S44, according to a current day of the week, the schedule file corresponding to the current day is retrieved from the optical information recording medium. For example, when the current day is Friday, the schedule file corresponding to Saturday is retrieved from the optical information recording medium.

In step S45, the method according to the third preferred embodiment of the invention monitors whether one of the starting times of the retrieved schedule file comes. If “Yes” in step S45, step S46 is then performed, the track number corresponding to the starting time coming is taken as a reproducing track number. Then step S47 is performed to retrieve the audio/video file recorded on the track which the reproducing track number indicates, and then to reproduce the retrieved vide/audio file.

A fourth preferred embodiment of the present invention is based on the third preferred embodiment with modifications. The optical information recording procedure according to the fourth preferred embodiment of the present invention is similar to the steps from S41 to S43, shown in FIG. 3. The difference between the two is that the fourth embodiment provides each schedule file with a plurality of ending times, respectively. In each schedule file, each ending time corresponds to one of the track numbers in step S42. The optical information reproducing procedure according to the fourth preferred embodiment carries out the steps from S44 to S47. After step S47, the retrieved audio/video file is repeatedly reproduced until the ending time, corresponding to the reproducing track number, comes.

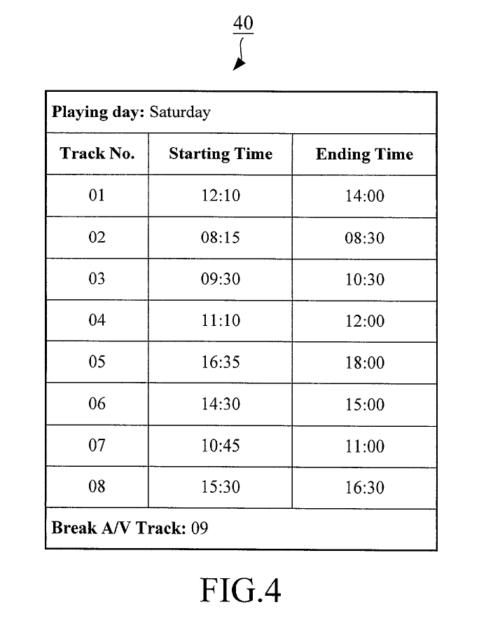

With respect to editing of the schedule files, taking the fourth preferred embodiment of the invention as an example, each schedule file corresponds to one of seven days of a week. Referring to FIG. 4, FIG. 4 is an example of a schedule file 40 corresponding to Saturday in the fourth preferred embodiment of the invention. As shown in FIG. 4, the schedule file 40 is operated by users in a table. The schedule file 40 corresponding to Saturday is displayed in “Playing day” column. The table shows the “Track No.” column, from 01 to 08, and each track number corresponds to one of the starting times and one of the ending times. The schedule file 40 is recorded onto the optical information recording medium together with the other six schedule files. When Saturday comes, the schedule file 40 is retrieved from the optical information recording medium. Afterwards, the retrieved audio/video files are reproduced according to the starting times and the ending times recorded in the schedule file 40.

By aforesaid preferred embodiments of the invention, it will be understood that the method according to the invention could reproduce audio/video files on specific locations in accordance with the schedule files previously edited. For example, to achieve a better “viewer impact” inspiring the advertisement sponsors, the commercial A/V contents broadcasted on an large outdoor LED panel can be scheduled by the method of the invention and based on the population around the LED panel

While the invention has been described in several preferred embodiments, it is understood that the words which have been used are words of description rather than words of limitation and that changes within the purview of the appended claims may be made without departing from the scope and spirit of the invention in its broader aspect. For example, the period, which the number of the schedule files is designed according to, can be a week or a month, even a season or a year. The method for recording and reproducing a plurality of audio/video files with a schedule according to the present invention is not only suitable for the optical information recording media, but also for other kinds of information storage devices.

What is claimed is:

1. A method for recording and reproducing a plurality of audio/video files from an optical information recording medium having a plurality of tracks, each audio/video file corresponding to one of the tracks, a plurality of track numbers being defined, each track number indicating one of the tracks, said method comprising the steps of:
(1) providing with a plurality of starting times which each corresponds to one of track numbers, and creating a schedule file comprising the track numbers and the corresponding starting times;
(2) recording the schedule file onto the optical information recording medium, and recording the audio/video files onto the corresponding tracks of the optical information recording medium;
(3) retrieving the schedule file from the optical information recording medium;
(4) according to the schedule file, monitoring whether one of the starting times comes;
(5) if YES in step (4), taking the track number corresponding to the starting time coming as a reproducing track number; and
(6) retrieving the audio/video file recorded on the track which the reproducing track number indicates, and reproducing the retrieved audio/video file.

2. The method according to claim 1, the step (1) also providing with a plurality of ending times which each corresponds to one of the track numbers, and the schedule file also comprising the corresponding ending times, said method further comprising the step of:
(7) repeatedly reproducing the retrieved audio/video file until the ending time, corresponding to the reproducing track number, comes.

3. A method for recording and reproducing a plurality of audio/video files from an optical information recording medium having a plurality of tracks, each audio/video file corresponding to one of the tracks, a plurality of track numbers being defined, each track number indicating one of the tracks, said method comprising the steps of:
(1) creating seven schedule files which each corresponds to one of seven days of a week, and providing each schedule file with the track numbers and a plurality of starting times, respectively, in each schedule file, each starting time corresponding to one of the track numbers;
(2) recording the seven schedule files onto the optical information recording medium, and recording the audio/video files onto the corresponding tracks of the optical information recording medium;
(3) according to a current day of the week, retrieving the schedule file corresponding to the current day from the optical information recoding medium;
(4) monitoring whether one of the starting times of the retrieved schedule file comes;
(5) if YES in step (4), taking the track number corresponding to the starting time coming as a reproducing track number; and
(6) retrieving the audio/video file recorded on the track which the reproducing track number indicates, and reproducing the retrieved vide/audio file.

4. The method according to claim 3, in step (1), also providing each schedule file with a plurality of ending times, respectively, in each schedule file, each ending time corresponding to one of the track numbers, said method further comprising the step of:
(7) repeatedly reproducing the retrieved audio/video file until the ending time, corresponding to the reproducing track number, comes.

5. A method for reproducing a plurality of audio/video files from an optical information recording medium having a plurality of tracks in accordance with seven schedule files, each schedule file corresponding to one of seven days of a week, each audio/video file corresponding to one of the tracks and being recorded on the corresponding track, a plurality of track numbers being defined, each track number indicating one of the tracks, each schedule file comprising the track numbers and a plurality of starting times, respectively, in each schedule file, each starting time corresponding to one of the track numbers, said method comprising the steps of:
(1) according to a current day of the week, taking the schedule file, corresponding to the current day, as a reproducing schedule file;
(2) monitoring whether one of the starting times of the reproducing schedule file comes;
(3) if YES in step (2), taking the track number corresponding to the starting time coming as a reproducing track number; and
(4) retrieving the audio/video file recorded on the track corresponding to the reproducing track number, and reproducing the retrieved audio/video file.

6. The method according to claim 5, each schedule file also comprising a plurality of ending times, respectively, in each schedule file, each ending time corresponding to one of the track numbers, said method further comprising the step of:
(5) repeatedly reproducing the retrieved audio/video file until the ending time, corresponding to the reproducing track number, comes.

7. The method according to claim 6, wherein the seven schedule files are recorded on the optical information recording medium.

8. A method for recording and reproducing a plurality of audio/video files from an optical information recording medium having a plurality of tracks, each audio/video file corresponding to one of the tracks, a plurality of track numbers being defined, each track number indicating one of the tracks, said method comprising the steps of:
(1) creating a plurality of schedule files which each corresponds to one of days of a month, and providing each schedule file with the track numbers and a plurality of starting times, respectively, in each schedule file, each starting time corresponding to one of the track numbers;
(2) recording the schedule files onto the optical information recording medium, and recording the audio/video files onto the corresponding tracks of the optical information recording medium;
(3) according to a current day of the month, retrieving the schedule file corresponding to the current day from the optical information recording medium;
(4) monitoring whether one of the starting times of the retrieved schedule file comes;
(5) if YES in step (4), taking the track number corresponding to the starting time coming as a reproducing track number; and
(6) retrieving the audio/video file recorded on the track which the reproducing track number indicates, and reproducing the retrieved vide/audio file.

9. The method according to claim 10, in step (1), also providing each schedule file with a plurality of ending times, respectively, in each schedule file, each ending time corresponding to one of the track numbers, said method further comprising the step of:
(7) repeatedly reproducing the retrieved audio/video file until the ending time, corresponding to the reproducing track number, comes.
